(19) United States
(12) Patent Application Publication
(10) Pub. No.: US 2005/0184719 A1
(43) Pub. Date: Aug. 25, 2005

(54) Cascade switching controller circuit

(76) Inventors: Marionito Castillo Figueroa, Scarborough (CA); Michael Madaric, Downsview (CA)

Correspondence Address: MARIONITO C. FIGUEROA, 10 WHEATON GROVE, SCARBOROUGH, ON, MIJ 3L5, CA

(21) Appl. No.: 10/708,296

(22) Filed: Feb. 23, 2004

(51) Int. Cl. G04F 8/00

(52) U.S. Cl. 323/318

(57) ABSTRACT

A circuit of electrical materials forming an electrical device so that when power is applied, it provides a cascade switching of power into a multiple load system such as in automotive power windows. When use as an automatic switching device to control a power windows system, a signal that latches or unlatches the power door locks triggers the controller causing the windows to fully close—to enhance security on a parked vehicle, or to fully open—to give convenience to the operator or safety to the endangered passengers.

### BRIEF DESCRIPTION OF DRAWINGS

FIG. 1 is an electrical circuit of a cascade switching controller and a set of five dc motors connected in a typical fashion to a box that contains the factory built switches and other control devices. (We present a typical car power windows electrical system as an application example.) FIG. 2 is a dc source that supplies power to the circuits in FIG. 1.

FIG. 1 is subdivided into 7 circuit blocks. Block 1 is an automatic on-off switch and timer circuit that powers on the system at a predetermined period of time. Block 2 is a sequential circuit that controls the switching of power from one motor to another and provides current drivers for various circuit outputs. Block 3 is a voltage regulator and filter circuit that supplies a regulated noise-free voltage needed by some elements of the system. Block 4 is a sync-sensor circuit that sensing the noise generated by the drive motors. Block 5 is an array of single pole double throw power relays that switch the high current required by the drive motors. Block 6 shows a wiring circuit of the drive motors and a box of factory devices as mentioned before. And Block 7 is a deterrent circuit, a safety feature used to suspend, when needed, the operation of the circuit in Block 2.

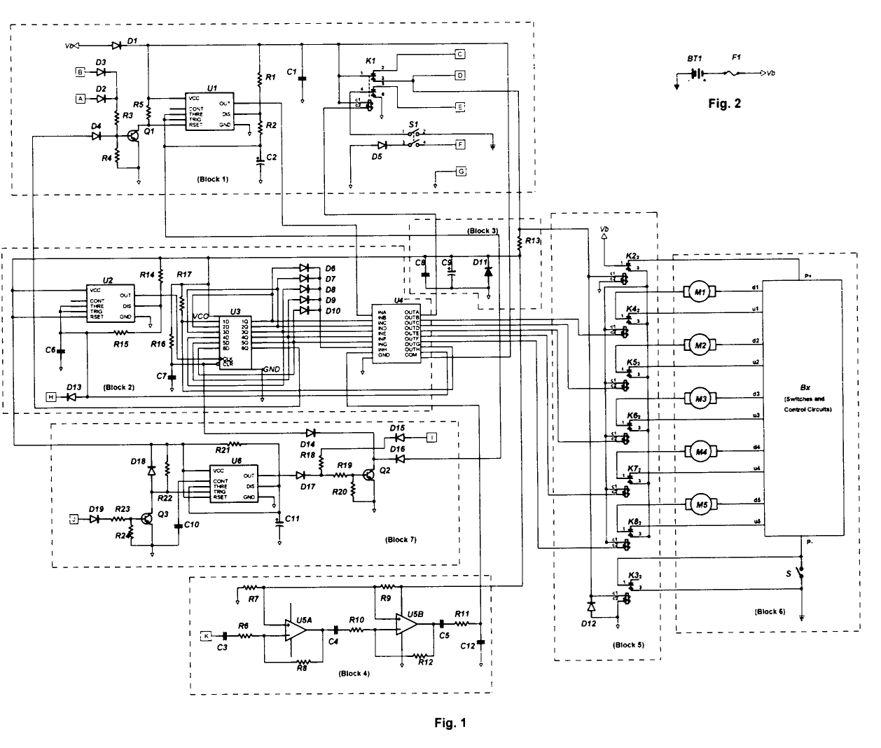

The circuit design applies the versatility of a combination of flip/flop, timer, and op-amp chips to perform a cascaded switching operation. The main component is a chip that contains an array of six sets of d-type positive-triggered flip/flop, controlled by a timer chip by generating the clock signal to it. The op-amp chip is sensing the motors noise current use to synchronize the switching operation. A ground potential signal supplied to the circuit common terminal powers up the system causing the first flip/flop to set into active state sending a high voltage signal to a power relay that energizes its associated drive motor. When a motor either spins or stalls, the op-amps send a corresponding signal to the clock input of the flip/flops through a timer chip.

A spinning motor causes its designated flip/flop to latch so that it remains energized. A stalled motor deactivates its designated flip/flop and sends its high state output signal down to the next flip/flop. The second motor is then energized while the first one is de-energized. Like the first flip/flop, the same functions of operation takes place and the sequence of switching power to the motors continues down to the third, and to the forth, and then to the last motor until the last active flip/flop high output state signal is sent to a timer power disable circuit that disconnects power from the source.

### DETAILED DESCRIPTION

In Blocks 5 and 6, a set of five dc motors are connected to a source positive potential Vb and ground through the power relays and a factory installed device box Bx. The power supply positive potential Vb is supplied to each dc motor through a main relay K2 contact pins 1 and 3 and through each of their designated driver relay K# contact pins 1 and 3, while the negative ground potential is provided through power relay K3 contact pins 1 and 3, P− terminal, box Bx, and d# terminals respectively. The relays pin 2 is a normally close contact pin, so that when the system is on the standby mode, the Vb potential is always present at a terminal P+ of the box Bx allowing a manual operation of the system. Likewise at standby mode, all terminals u# and d# of the box Bx are connected to the negative ground potential, so that, with the activation of the power relays by the controller circuit, an automatic switching operation can be performed. A power relay K3 is added to ensure that a ground potential is always applied to the P− terminal, even when a factory built switch S is left open.

For automatic operation, which is the purpose of this invention, Block 1 circuit is preferably needed to function in order to power up the controller. Block 1 circuit has two main components, a Timer chip U1 and a double-pole-double-throw relay switch K1. A double-pole-single-throw switch S1 is added to use as a manual disable switch. The other associate components are the rectifier diodes D1, D2, D3, D4, and D5 that block the undesired signals. The terminals C, D, E, and G are intended for optional devices that can be interfaced with the sys-tem. The VCC pin of the timer U1 is connected to the Vb potential through the diode D1, while its GND pin is connected to the common terminal of the circuit. A capacitor C1 is shunted across the pin 1 of the relay K1 and the circuit common terminal to shunt any suppress noise to the ground developed by its switching contacts.

The Vb potential is applied to the relay K1 coil pin c1 through the diode D1, and the pin c2 is connected to the circuit common terminal through a driver transistor integrated inside the chip U4 of Block 2. Two resistors, R1 and R2, are connected to DIS pin of U1. The other side of R1 is connected to the Vb potential through D1, while the other side of R2 is connected in series with a capacitor C2 which other pin is connected to the circuit common terminal. The line of connection between R2 and C2 is then connected to the joint pins TRIG and THRE of the timer U1. The values of R1 and C2 determine the length of time the system keeps the power on, that limits the operation time to avoid damage to the motors when malfunction occurs.

The Timer chip and its associated components form a basic astable timer circuit that provides 3 different functions as; a power-on switch, a time-delay timer, and a power disable circuit. A NPN transistor Q1 is used as a switch to reset the timer U1 that is its function as a power disable device. The collector pin of Q1 is connected to a line between the RSET pin of the timer and the resistor R5 forming a junction. The other side of R5 is connected to the source Vb via the diode D1. The emitter pin of Q1 is connected to the circuit common terminal. Two resistors R3 and R4 and a diode D4 are connected together forming a junction that is connected to the base pin of the transistor Q1. The other side of R4 is connected to the circuit common terminal and the opposite side of R3 is connected to the cathode pins of D2 and D3. Their anodes are then connected to each input terminal, D2 to A and D3 to B respectively. The diode D4 passes the positive signal that comes from a source in Block 2 that is to be discussed later.

When a momentary negative signal, with a time duration that is not less than 20 milliseconds, is applied to the input terminal F, it is instantly supplied to the circuit common terminal through the switch S1 and the diode D5. At this instance, when both terminals A and B receive no power-disable signals, the timer U1 starts the cycle causing C2 to charge. Without positive signal applied to both terminals A and B, the base of transistor Q1 has no bias voltage and causes it to maintain a high impedance or non-conducting state, that keeps the RSET pin of U1 to remain disconnected from the ground potential. This condition causes a high voltage output at the OUT pin of the timer U1. Otherwise, the output is remained relatively low at ground potential that disables the system power application.

The high voltage at the OUT pin of U1, which is connected to the input INA pin of a driver chip U4 in Block 2 as describe before, causes a low output signal at the OUTA pin that is a ground potential at the circuit common terminal. This ground potential activates the relay K1 that causes its pin 4 to close contact with pin 6 that is permanently connected to the circuit common terminal. The negative ground potential of the power supply will be directly applied to the circuit common terminal through closed contact pins 1 and 2 of switch S1 as well with close contact pins 4 and 6 of the relay K1. Then the negative signal at the terminal F eventually becomes irrelevant. At the same instance, the relay K1 pin 1, that is ganged with pin 4, and pin 3 make a close contact that connects the potential Vb to the various segments of the circuit making the system power on and ready to perform an automatic switching operation. The relay K1 remains activated until either a complete operation is accomplished or the time delay set by C2 and R1 expires.

Right after the relay K1 becomes activated, both relays K2 and K3 parallel connected coil pins c1 and c2, that are shunted with a suppressor diode D12 (the cathode at pin c1 and the anode at pin c2), are connected to the power supply; c1 pins—to the Vb potential through relay K1 pins 3 and 1 through diode D1, while c2 pins—to the ground potential through the circuit common terminal. This makes the relays K2 and K3 active that causes K2 pin 1 to close contact with pin 3 that supplies the Vb potential straight to the coil pins c1 of all the rest of the power relays. The closed contact pins 1 and 3 of the relay K3 bypasses switch S that connects a ground potential to the P− terminal of the box Bx. This condition makes all the drive motors to have a potential to spin just by applying a negative voltage to pin c2 of their designated power relay.

In Block 2, three chips are used to form the main circuit that generates and processes the switching signals fed to the power relays in Block 5. The Vb potential that is supplied to the VCC pins of the chips U2 and U3 as well with the other chips in Blocks 4 and 7 is dropped, regulated, and filtered by a voltage regulator of the Block 3 circuit which is typically consists of; a Zener diode D11, a voltage dropping resistor R13, and two filter capacitors C8 and C9. Hereafter, we will alternately refer to the regulated voltage Vcc and the negative circuit common terminal as V+ and V− for simplicity. The chip U3, that is an array of six positive-edge triggered D-type flip/flops, is used to provide a cascaded signal needed by the driver chip U4 to activate the power relays one at a time. The chip U2 is another Timer chip that is used to generate clock pulses required by the flip/flops chip. The chip U4 as mentioned before is an array of drivers consists of eight Darlington transistors, each with integral suppression diode, and with its Com pin directly connected to Vb through diode D1. An astable timer circuit of chip U2, like the first timer chip U1, is associated with two resistors and a capacitor. The two resistors, R14 and R15, and a capacitor C6 are connected in series. The line between R14 and R15 is connected to a DIS pin of the timer U2, while the other side of R15 is connected to a junction formed by C6 and the timer joint pins THRE and TRIG respectively. This junction is also connected to the other components of the circuit that responsively react to suspend the timer U2 operation. The other side of C6 and the timer GND pin are connected to the circuit common terminal while the other side of the resistor R14, the pins of VCC and RSET, are all connected to the V+ source. The pulse signal generated by the timer U2 that comes out from its OUT pin is then fed to the input CLK pin of U3.

The flip/flops chip U3 is associated with two resistors, R16 and R17, a capacitor C7, and five rectifier diodes D6, D7, D8, D9 and D10. Two common inputs, CLK and CLR, control the flip/flops. The V+ and V− potentials are applied across the VCC and GND pins accordingly. A resistor R17 is used as a load resistor connected to a driver output OUTG pin of U4. The connection line between R17 and the output OUTG pin of U4 is then connected to the input 1D terminal pin. Both resistor R16 and capacitor C7 combine a series connection as a timer to delay an input signal. The other side of R16 is connected to the V+ while the other side of C7 is grounded through the circuit common terminal. The CLR pin of U3 is connected to the joint pins of R16 and C7 forming a junction that is then connected to a line going to the Deterrent circuit of Block 7.

When power is applied, the V+ voltage is instantly supplied to the first flip/flop input 1D pin through R17. The capacitor C7 starts charging through the resistor R16. The RC Time Constant of their combined values causes the CLR pin of U3 to receive a slow increasing voltage. Just before C7 starts to charge, the low voltage at the CLR pin initially set all the flip/flops output to low. When the voltage across C7 has increased into a high level of signal required by the CLR pin of U3, the rising positive voltage of a pulse signal at the CLK pin sets the output IQ of U3 into a high state. This output pin is connected to a junction that splits into three different lines; the first line directly connects the input INB of U4, the second line leads to the input ING of the same chip through a diode D6, and the third line goes to the Input 2D of the second flip/flop.

The high voltage signal at the output 1Q of U3 is utilized to perform three different functions: First, the high voltage it sends to the input INB of the chip U4 causes its designated output OUTB to set a low state signal that is a negative ground potential. This ground potential is then applied to the coil pin c2 of the power relay K4. Since the other side of the coil is already connected to the Vb potential through relay K2 contacted pins 1 and 3, relay K4 will be activated causing its common contact pin 1 to open contact with pin 2—disconnecting the ground potential, and to close contact with pin 3 connecting the Vb potential. Both terminals of the dc motor M1 are now connected to the Vb and ground of the power supply. The Vb potential is connected through contact pins 1 and 3 of the power relays K2 and K4 respectively, while the ground potential is obtained through contact pins 1 and 3 of the power relay K3, P− terminal, box Bx, and d1 terminal. The motor M1 spins if the window driven by it is open, otherwise, it remains stalled.

A spinning motor generates noise in form of current pulses at both sides of the terminal of the power supply. Base from our experience, we have observed that the best spot to sense motor noise is at the negative line close to the motor. The noise current and the conductor resistance between the negative terminal of the motor and the power supply produce a few milli-volt of varying voltage drops. The Op Amp chip U5 in Block 4 (this circuit will be described later) amplifies these small varying voltages. The amplified motor noise becomes a high power of pulses that is good enough to use as a sync signal. This sync signal that comes out from the amplifier circuit is fed to the input base of a driver transistor, that is integrated inside the chip U4, through the input INH and causes a changing state output at the collector that is internally connected to the output OUTH. This signal is then fed to a junction formed by C6, D13, R15, and the joint pins THRE and TRIG of the timer chip U2. The frequency of this motor noise signal is practically much greater than the oscillating frequency produced by the timer U2, so that every time a motor noise is present, the capacitor C6 is repeatedly discharging before attaining a Threshold voltage. Therefore, the timer stops generating pulses sending a steady state of signal at the input CLK of U3. This latches the high state output of 1Q that further keeps the motor M1 spinning until the window is fully closed.

The second function of the high state output Q is to switch its input D from high to low state. This is done by converting the high state signal of 1Q to low state signal and feeds back to its input 1D through its designated rectifier diode D6 and its designated driver transistor integrated inside the chip U4. The output 1Q pin is connected to the anode of D6 and its cathode is then connected to the input ING pin of U4. The high state signal at the input ING corresponds a low or ground potential at the output OUTG. This ground potential signal is then sent to a line of connection between the load resistor R17 and the input 1D of U3 that practically changes its state from high to low. At the same time, the high output 1Q sets the input 2D to high state by a direct connection between their pins. This setup prepares the transfer of the switching operation to the next flip/flop, which is the third function of the high output Q.

A stalled or non spinning motor produces no noise signal at all. When the motor M1 is stalled or stops from spinning for any reason, the high output state of 1Q will keep it energized in a short period of time set by the combined values of R14, R15, and C6. And when there is no motor noise to use as signal to stop the timer U2 from generating clock pulses, the positive going edge of a clock pulse sets the output 2Q of the second flip/flop to high state while the output 1Q of the first flip/flop changes from high to low state. Therefore, the second motor M2 is energized while the first motor M1 becomes de-energized, and all the three functions of the previously high output 1Q will be performed as well by the currently high output 2Q. The same circuit operation takes place when the switching sequence advances to the next motor M3, then to M4, and then to the last motor M5.

The Block 2 drawing is also showing that all the cathodes of the rectifier diodes, from D6 to D10, are commonly connected to a single input ING pin of the chip U4. While their anode pins are separately connected in the following manner: Like the diode D6, the anode pin of D7 is connected to a junction formed by the input 3D of U3, the output 2Q, and the input INC of U4. The Diode D8 anode similarly goes to a junction formed by the input 4D, the output 3Q, and the input IND of U4. The anode pin of D9 is likewise connected to a junction formed by the input 5D, the output 4Q, and the input INE of U4. And the last diode D10, its anode pin is connected going to a junction made up by the input 6D, the output 5Q, and the input INF of U4. These diodes make the flip/flops outputs (1Q to 5Q) isolated from each other.

When the last motor M5 is energized, the high state output of 5Q is fed to the input 6D of the last flip/flop so that the positive going edge of the next clock pulse will trigger a high state output at 6Q. This high state of signal is then fed to the base of the power transistor Q1 through the diode D4, that causes Q1 to set into a low impedance or conducting state. This conducting state of Q1 connects the RSET pin of U1 to the ground. When a negative potential is applied to the RSET pin of the timer U1, its Out pin switches from high into a relatively low state. This low state of voltage applied to the input INA of U4 corresponds to a high or non-conducting output state at OUTA that is connected to the coil pin c2 of the relay K1. A disconnected c2 pin from the ground potential deactivates the relay K1 causing the common pin 1 to release contact with pin 3 disconnecting the Vb potential, while the common pin 4, that is ganged with common pin 1, releases contact with pin 6 disconnecting the circuit common terminal from the negative ground potential. Therefore, the system shuts off before a predetermined period of time sets by R1 and C2 expires.

The Deterrent circuit in Block 7 is mainly made up of another Timer chip and two NPN power transistors. The timer U6 is used as a time delay device that provides a high state output at OUT pin when cycle begins. Typically, the V+ is applied on both pins of VCC and RSET while V− is applied at GND pin. The cycle time is set by the combined values of resistor R21 and capacitor C11. One side of R21 is connected to the V+ and the other side is connected in series with C11 with negative pin connected to the circuit common terminal. The line between R21 and C11 is connected to the joint pins of THRE and DIS. A capacitor C10 is shunted across CONT pin and the circuit common terminal. The TRIG pin is connected to a junction formed by a load resistor R22, a rectifier diode D18, and a NPN transistor Q3. The other side of R22 and the cathode of D18 are both connected to the V+ potential while the emitter pin of the transistor Q3 is connected to the circuit common terminal. The anode of D18 is connected to the TRIG pin to protect the timer against any suppress voltage that may develop on the TRIG line, while the capacitor C10 is use to provide a bounce-free CONT line, so that the timer is protected against any false trigger signal. Two resistors R23 and R24 are connecting a line that provides a biasing network to the base of Q3. The other side of R24 is connected to the circuit common terminal while the other side of R23 is connected to an input J terminal via a blocking diode D19. The diode D19 is used to pass a positive signal that comes from external source.

The drawing also illustrates that the OUT pin of U6 is connected to the base pin of the power transistor Q2 through a rectifier diode D17 and a resistor R19. Another input point designated as terminal I, that also receives a positive signal from external source, is connected to a line between the D17 and R19 through a dropping resistor R18 and a rectifier diode D15. The resistor R20 shunts the base pin of Q2 from the ground forming a junction with R19 to provide a biasing circuit. The diode D17 is used to block the OUT pin of U6 from the positive signal that comes in the input I terminal. The collector pin of Q2 is connected to the cathode of two diodes, D14 and D16. The anode of D14 is connected to a junction formed by R16, C7, and the CLR pin of U3. While the anode of D16 goes to a junction formed by C2, R2, and the joint pins of THRE and TRIG of U1. The emitter pin of Q2 is grounded through the circuit common terminal.

A momentary positive signal applied to the input J terminal causes Q3 to have a low impedance output. This low impedance or conducting state of Q3 momentarily connects the TRIG pin of the timer U6 to the ground that starts a timer cycle causing the OUT pin to deliver a high voltage signal to the base of the power transistor Q2. This voltage causes Q2 to switch to its conducting state that connects a ground potential to both the CLR pin of U3 and the high side terminal of C2. A grounded CLR pin of U3 clears or switches all the flip/flops output into low state. This causes a closing window to stop moving up that is a safety feature of this invention. Likewise, a grounded C2 causes to discharge so that the timer U1 extends its on-cycle. When the timer cycle of U6 expires, its OUT pin becomes low that switches Q2 back to non-conducting state disconnecting the ground from CLR pin of U3 and capacitor C2. Then U3 restarts its operation, setting all outputs, from 1Q to 6Q, into momentarily high state one at a time, a cascade switching as described before, causing the interrupted open window to resume closing. The capacitor C2 begins to recharge voltage for a full time cycle. When a positive signal is applied to the input I terminal, the base of Q2 receives a biasing voltage through D15, R18, and R19 that makes Q2 to switch into a conducting state. This has the same effect when a positive signal is applied to the J input terminal except that Q2 remains conducting only during the presence of a positive signal at the input I terminal.

The Block 4 sync-sensor circuit is mainly made up of a dual op-amp chip that comprises two stages, U5A and U5B, amplifier that convert the motor noise into high voltage square waves signal. Like a typical single supply dual op-amp, the power supply V+ and ground are connected to its VCC and GND pins respectively. Two resistors R7 and R9 are connected in series forming a voltage divider that supplies a stable voltage to the non-inverting (+) inputs of the op-amps. The other side of R7 is connected to the circuit common terminal while the other side of R9 is directly connected to the V+ source. When a motor spins, the first stage op-amp chip U5A amplifies the motor noise signal that is sensing by the inverting input (−) pin through the input K terminal, capacitor C3, and resistor R6. The terminal K links the sync signal, that is motor noise in this application, that comes from the Box Bx in Block 6 as described before.

The same components configuration makes the circuit of the second stage op-amp identical with the first op-amp. The amplified motor noise from the first stage output pin is then fed to the inverting input (−) pin of the second op-amp U5B through a link capacitor C4 and an input resistor R10. More voltage amplification takes place in U5B before the signal is fed to a driver transistor inside U4. The high voltage signal is then applied to the input INH pin of U4, as described before, through a capacitor C5 and a resistor R11. The reactance value of resistor R11 combined with capacitor C12 creates a low-pass filter allowing the needed signal to pass.

The terminals H and K can be connected to other appropriate source of sync signal to enable the device to control different types of load or system. To conclude, there are many options that may rise and offer a great deal of opportunity in the application as well with the modification or variation on this invention as long as the original scope remains intact.

1. We claim, an electrical circuit that provides a cascade switching of power into a multiple load system comprising;

2. A timer-switch circuit consisting of a timer chip associated with sets of transistor, resistor, diode, and capacitor that activates a double-pole-double-throw relay and with accessible terminals designated as C, D, E, F, and G.

3. A circuit comprising an array of power relays, with one primary relay that provides a common power feeder to a plurality of secondary relays that switch power connection line between factory wiring system and primary relay common power feeder, and with one power relay that bypasses the factory disconnect switch.

4. A Sequential circuit consisting of a multiple flip-flops chip associated with sets of diode, resistor, capacitor, and a chip of power drivers with common positive pin connected to the positive terminal of the dc source through a rectifier diode.

5. A Pulse Generator that generates clock signals supplied to said circuit consisting of a timer chip combined with resistor, capacitor, and diode sets, that receives sync signals through Sync-sensor and accessible input designated as terminal H.

6. A Sync-sensor system comprising a dual op-amp associated with sets of resistor and capacitor with an accessible input designated as terminal K, and with an output connected to said circuit supplying the amplified sync signal.

7. The Timer-switch circuit defined in claim 1 further comprising a power transistor associated with sets of diode and resistor with accessible signal input terminals, designated as A and B, use as paths for passing power-disable signals, and has a direct connection to said circuit sending power-off signal.

8. A Deterrent system that suspends and resumes operation of said circuit consisting of a timer chip with associated components of resistor, capacitor, and diode, having means to perform different functions;
A circuit wherein said means comprises a pair of transistors, wherein first transistor having means to trigger said timer causing second transistor having means applying ground potential to both reset pin of said flip-flops chip in claim 2 and timer circuit junction in claim 1.
A circuit that receives signal through an accessible input designated as J terminal, wherein said first transistor means comprising sets of resistor and diode.
A circuit with an accessible signal input designated as I terminal, wherein said second transistor means associated with sets of diode and resistor.
